(19) United States
(12) Patent Application Publication
(10) Pub. No.: US 2024/0245972 A1
(43) Pub. Date: Jul. 25, 2024

(54) SYSTEM AND METHOD FOR ANALYZING GOLF SWING VIDEOS AND GENERATING EFFECTIVE GOLF ADVICE USING ARTIFICIAL INTELLIGENCE

(71) Applicant: Xonic Golf Inc., Toronto (CA)

(72) Inventor: Eileen Jurczak, Toronto (CA)

(21) Appl. No.: 18/564,227

(22) PCT Filed: May 25, 2022
(86) PCT No.: PCT/CA2022/050827

§ 371 Date: Nov. 27, 2023

Related U.S. Application Data
(60) Provisional application No. 63/197,787, filed on Jun. 7, 2021.

(51) Int. Cl. A63B 71/06; A63B 102/32; G06V 20/40; G06V 40/20

(52) U.S. Cl. CPC A63B 71/0622; G06V 20/42; G06V 40/28; A63B 2102/32; A63B 2220/05; A63B 2220/806

(57) ABSTRACT

An automated system and method for analyzing a golf swing video and generating golf professional advice using artificial intelligence (AI). The system receives user video data from a user device; generates user swing signature data from the user video data using an initial AI; generates golf professional advice outputs from the user swing signature data using a final AI; and sends the golf professional advice outputs to the user device to be output on the user device. The final AI may take as input the user swing signature data or user profile class data, as well as golf professional advice data and user feedback data. The user profile class data may be generated based on user profile data and an intermediate AI, where the user profile data is based on the user swing signature data and other user data.

### FIELD

Various embodiments are described herein that generally relate to a system for analyzing golf swing videos and generating effective golf advice, as well as the methods and computer program products thereof.

### BACKGROUND

The following paragraphs are provided by way of background to the present disclosure. They are not, however, an admission that anything discussed therein is prior art or part of the knowledge of persons skilled in the art.

Currently, golfers have access to different technology tools to help them improve their golf game. Some technology tools use sensors and measuring devices attached to the golf club or the golfer's body, to track and analyze a multitude of statistics related to the motion of the user's golf club and the distance/direction of the user's golf ball, where recommendations produced are numerical/statistical outputs based on the aggregation of the measured statistics. Other technology tools provide automated lesson plans that teach users how to change their swing to emulate the swing of a golf professional; these automated lesson plans leverage the expertise of a limited number of golf professionals, where all users receive the same lesson plans from the same golf professionals. These technology tools may not be convenient or inexpensive, and they may not be the most effective at improving the golfer's game.

There is a need for a system and method that addresses the challenges and/or shortcomings described above.

### SUMMARY OF VARIOUS EMBODIMENTS

Various embodiments of a system and method for analyzing golf swing videos and generating effective golf advice using artificial intelligence and computer products for use therewith, are provided according to the teachings herein.

According to one aspect of the invention, there is disclosed an automated system for analyzing a golf swing video and generating golf professional advice using artificial intelligence (AI) comprising: at least one processor; a non-transitory computer-readable medium having stored thereon instructions that, when executed by the at least one processor, cause the at least one processor to carry out the steps of: receiving user video data from a user device; generating user swing signature data from the user video data using an initial AI that takes as input the user video data; generating one or more golf professional advice outputs from the user swing signature data using a final AI; and sending the one or more golf professional advice outputs to the user device for use to cause to be output on the user device.

In at least one embodiment, the final AI takes as input the user swing signature data and golf professional advice data.

In at least one embodiment, the final AI further takes as input other user data.

In at least one embodiment, the instructions further cause the at least one processor to carry out the step of: generating user profile class data based at least in part on the user swing signature data and an intermediate AI; and the final AI takes as input the user profile class data and golf professional advice data.

In at least one embodiment, the instructions further cause the at least one processor to carry out the steps of: generating user profile data based at least in part on the user swing signature data and other user data; and generating user profile class data based at least in part on the user profile data and an intermediate AI; and the final AI takes as input the user profile class data and golf professional advice data.

In at least one embodiment, the user video data received from the user device is recorded video that captured a golf swing or stroke.

In at least one embodiment, the generating the one or more golf professional advice outputs is done at least in part by the final AI scoring at least two candidates for advice and selecting the one of the at least two candidates with a higher score.

In at least one embodiment, the scoring of the at least two candidates is based at least in part on user feedback data.

In at least one embodiment, the initial AI is a pose estimator.

In at least one embodiment, the final AI further takes as input user feedback data.

In another aspect, there is disclosed an automated method for analyzing a golf swing video and generating golf professional advice using artificial intelligence (AI) comprising: receiving user video data from a user device; generating user swing signature data from the user video data using an initial AI that takes as input the user video data; generating one or more golf professional advice outputs from the user swing signature data using a final AI; and sending the one or more golf professional advice outputs to the user device for use to cause to be output on the user device.

In at least one embodiment, the final AI takes as input the user swing signature data and golf professional advice data.

In at least one embodiment, the final AI further takes as input other user data.

In at least one embodiment, the automated method further comprises: generating user profile class data based at least in part on the user swing signature data and an intermediate AI; and the final AI takes as input the user profile class data and golf professional advice data.

In at least one embodiment, the automated method further comprises: generating user profile data based at least in part on the user swing signature data and other user data; and generating user profile class data based at least in part on the user profile data and an intermediate AI; and the final AI takes as input the user profile class data and golf professional advice data.

In at least one embodiment, the user video data received from the user device is recorded video that captured a golf swing or stroke.

In at least one embodiment, the generating the one or more golf professional advice outputs is done at least in part by the final AI scoring at least two candidates for advice and selecting the one of the at least two candidates with a higher score.

In at least one embodiment, the scoring of the at least two candidates is based at least in part on user feedback data.

In at least one embodiment, the initial AI is a pose estimator.

In at least one embodiment, the final AI further takes as input user feedback data.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 shows a block diagram of an example embodiment of a system for analyzing golf swing videos and generating effective golf advice using AI.

FIG. 2 shows a block diagram of an example embodiment of data flow for the system of FIG. 1.

FIG. 3 shows a block diagram of an example embodiment of an interaction between user video data, AI model(s) and/or algorithm(s), and user swing signature data.

FIG. 4 shows a block diagram of an example embodiment of an interaction between user swing signature data, other user data, and user profile data.

FIG. 5 shows a block diagram of an example embodiment of an interaction between user profile data, AI algorithm(s) and/or other algorithm(s), and user profile class data, for a full swing.

FIG. 6 shows a block diagram of an example embodiment of an interaction between user profile class data, golf professional advice data, other user data, AI algorithm(s), user feedback data, golf professional advice output, and a user interface, for a full swing.

FIG. 7 shows a block diagram of an example embodiment of the system receiving golf professional advice data and generating golf professional advice output, for a full swing and user profile class A.

FIG. 8 shows a block diagram of an example embodiment of an infrastructure for the system of FIG. 1.

FIG. 9 shows a flowchart of an example embodiment of a setup process for a new user of the system of FIG. 1.

FIG. 10 shows a flowchart of an example embodiment of an interaction of a user with the system of FIG. 1.

Further aspects and features of the example embodiments described herein will appear from the following description taken together with the accompanying drawings.

### DETAILED DESCRIPTION OF THE EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems, or methods having all of the features of any one of the devices, systems, or methods described below or to features common to multiple or all of the devices, systems, or methods described herein. It is possible that there may be a device, system, or method described herein that is not an embodiment of any claimed subject matter. Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical signal, electrical connection, or a mechanical element depending on the particular context.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5%, or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

It should also be noted that the use of the term “window” in conjunction with describing the operation of any system or method described herein is meant to be understood as describing a user interface for performing initialization, configuration, or other user operations.

The example embodiments of the devices, systems, or methods described in accordance with the teachings herein may be implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including at least one of a touch screen, a microphone, a keyboard, a mouse, buttons, keys, sliders, and the like, as well as one or more of a display, a printer, and the like depending on the implementation of the hardware.

It should also be noted that there may be some elements that are used to implement at least part of the embodiments described herein that may be implemented via software that is written in a high-level procedural language such as object-oriented programming. The program code may be written in C++, C#, JavaScript, Python, or any other suitable programming language and may comprise modules or classes, as is known to those skilled in object-oriented programming. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, a USB key, and the like that is readable by a device having a processor, an operating system, and the associated hardware and software that is necessary to implement the functionality of at least one of the embodiments described herein. The software program code, when read by the device, configures the device to operate in a new, specific, and predefined manner (e.g., as a specific-purpose computer) in order to perform at least one of the methods described herein.

At least some of the programs associated with the devices, systems, and methods of the embodiments described herein may be capable of being distributed in a computer program product comprising a computer readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

In accordance with the teachings herein, there are provided various embodiments for analyzing golf swing videos and generating effective golf advice using artificial intelligence, and computer products or systems for use therewith.

Golfers do not currently have access to a convenient and inexpensive technology tool to help them improve their game that does not use markers, sensors, or measuring devices, that does not present the user with statistics, and that does not try to change the golfer's swing to emulate the swing of a golf professional. Moreover, golfers do not currently have access to a convenient and inexpensive technology tool to help them improve their game by receiving quick and useful golf professional advice while the user is playing golf, regardless of the golf course they are playing at. Lastly, golfers do not currently have access to a convenient and inexpensive technology tool that allows them to quickly access golf professional advice from multiple golf professionals that communicate their advice in a way that matches each golfer's learning style and ability to process information.

In at least one embodiment, the system provided in accordance with the teachings herein is a continuously adapting, dynamic system that uses a mobile device to capture and record videos of a golfer's swing from both face-on and down-the-line views for one or more swing (or stroke) types, including, for example: full swing; pitching swing; chipping swing; greenside sand swing; and putting stroke. The system can pre-process the video data and can use one or more artificial intelligence (AI) models and/or algorithms to convert this video data into swing signature data that can capture multiple aspects of the position and movement of the golfer's body, golf club, and ball throughout the swing, for each golfer's unique swing. This swing signature data can be combined with other user data to create user profile data, which can be analyzed using another set of one or more AI algorithms and/or other algorithms to create different classes of user profiles, based on the similarities and/or differences among the unique user profile data sets created for all users. These different user profile classes, other user data, as well as a plurality of golf professional advice data from a plurality of golf professionals, and user feedback data, can be received by another set of one or more AI algorithms to generate effective golf professional advice output for each golfer (e.g., in real time or on demand), to help each golfer with specific situations and/or issues they encounter while they are golfing, either on the golf course or on the driving range. The system may be configured to select the most effective golf professional advice output (e.g., based on scores or rankings). User feedback data can identify whether or not the advice provided was useful for the golfer. The system can receive user feedback data as an input, along with continuously updated user profile data and golf professional advice data, to continuously update and improve the golf professional advice output generated for each user so that effective golf professional advice output for each golfer and their swing is presented to the user through the user interface on their mobile device.

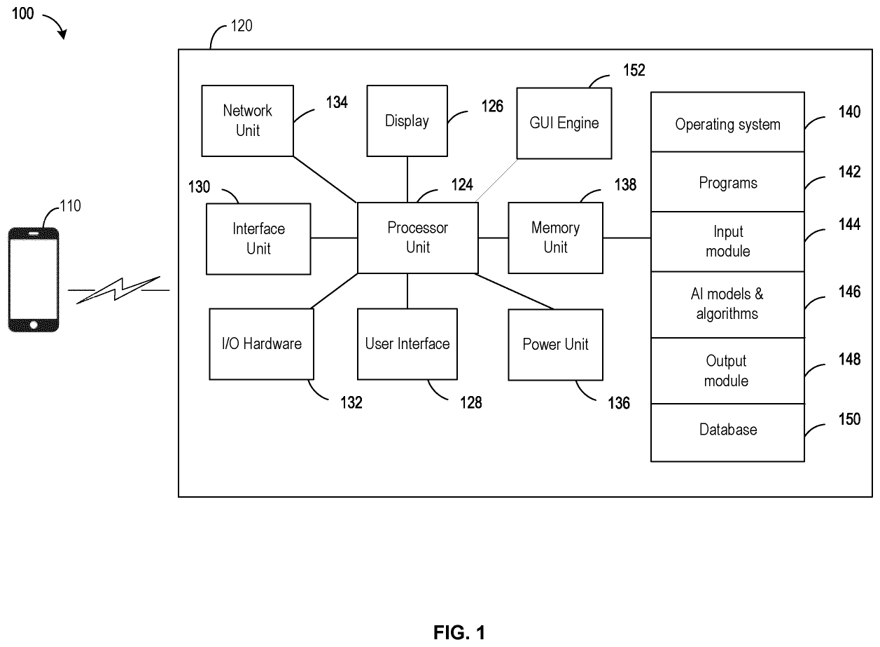

Reference is first made to FIG. 1, showing a block diagram of an example embodiment of a system 100 for analyzing golf swing videos and generating effective golf advice using AI. The system 100 includes at least one user device 110 and at least one server 120. The user device 110 and the server 120 may communicate, for example, wirelessly or over the Internet.

The user device 110 may be a computing device that is operated by a user. The user device 110 may be, for example, a smartphone, a smartwatch, a mobile device, a tablet computer, a laptop, a virtual reality (VR) device, or an augmented reality (AR) device. The user device 110 may also be, for example, a combination of computing devices that operate together, such as a smartphone and a sensor. The user device 110 may also be, for example, a device that is otherwise operated by a user, such as a drone, a robot, or remote-controlled device; in such a case, the user device 110 may be operated, for example, by a user through a personal computing device (such as a smartphone). The user device 110 may be configured to run an application (e.g., a mobile app) that communicates with other parts of the system 100, such as the server 120.

The server 120 may run on a single computer, including a processor unit 124, a display 126, a user interface 128, an interface unit 130, input/output (I/O) hardware 132, a network unit 134, a power unit 136, and a memory unit (also referred to as “data store”) 138. In other embodiments, the server 120 may have more or less components but generally function in a similar manner. For example, the server 120 may be implemented using more than one computing device.

The processor unit 124 may include a standard processor, such as the Intel Xeon processor, for example. Alternatively, there may be a plurality of processors that are used by the processor unit 124, and these processors may function in parallel and perform certain functions. The display 126 may be, but not limited to, a computer monitor or an LCD display such as that for a tablet device. The user interface 128 may be an Application Programming Interface (API) or a web-based application that is accessible via the network unit 134. The network unit 134 may be a standard network adapter such as an Ethernet or 802.11x adapter.

The processor unit 124 can also execute a graphical user interface (GUI) engine 152 that is used to generate various GUIs. The GUI engine 152 provides data according to a certain layout for each user interface and also receives data input or control inputs from a user. The GUI then uses the inputs from the user to change the data that is shown on the current user interface, or changes the operation of the server 120 which may include showing a different user interface.

The memory unit 138 may store the program instructions for an operating system 140, programs 142 for other applications, an input module 144, a plurality of AI models and algorithms 146, an output module 148, and a database 150. The database 150 may be, for example, a local database, an external database, a database on the cloud, multiple databases, or a combination thereof.

The programs 142 comprise program code that, when executed, configures the processor unit 124 to operate in a particular manner to implement various functions and tools for the system 100.

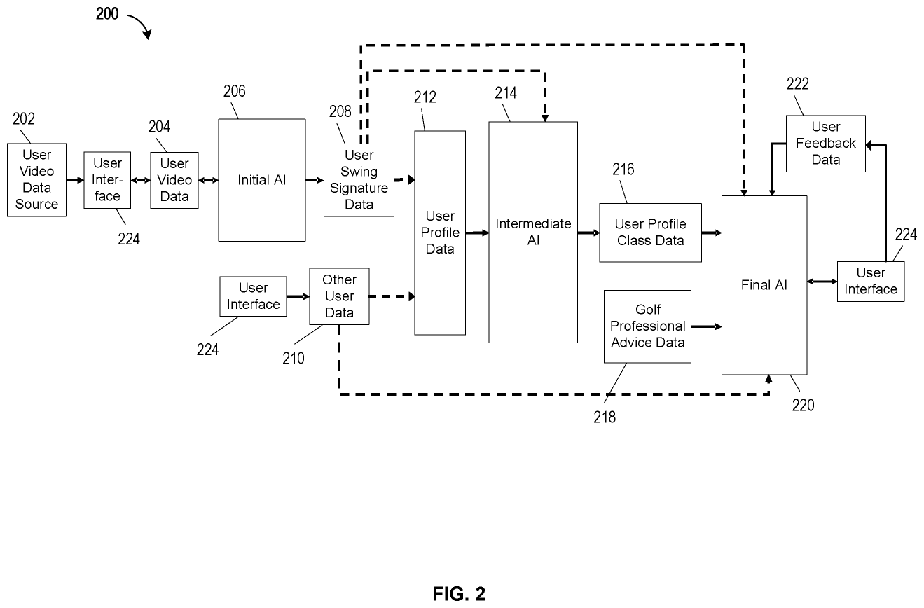

Reference is made to FIG. 2, showing a block diagram of an example embodiment of data flow 200 for the system 100. The data flow 200 allows the system 100 to continuously adapt to the user to generate effective golf professional advice output for each golfer and their swing (e.g., in real time or on demand), without the use of markers or sensors attached to the golf club or the golfer's body. The golf professional advice output generated for each user may be, for example, from a particular golf professional, the collective experience of a selection of golf professionals, from a plurality of golf professionals, or from an AI representation of a golf professional. The data flow 200 can include inputs such as user video data 204, user swing signature data 208, other user data 210, user profile class data 216, golf professional advice data 218, and user feedback data 222, which can be received via three sets of one or more AI models and/or algorithms, or other algorithms, 206, 214, and 220, to generate output data (e.g., the user swing signature data 208 and the user profile class data 216) and the final golf professional advice output, which is presented to the user via a user interface 224 (e.g., on user device 110). The system 100 may send the golf professional advice output to the user device 110 so that the user device 110 can output the golf professional advice output in the form of video, audio, text, images, or any combination thereof. The one or more AI models and/or algorithms, or other algorithms, 206, 214, and 220, may be stored in the memory unit 138 as programs 142 and/or AI models and algorithms 146.

For ease of reference, the first of the three sets of one or more AI models and/or algorithms, or other algorithms 206, 214, and 220 may be referred to as “one or more AI models and/or algorithms 206”, or more simply “initial AI 206”. The second of the three sets of one or more AI models and/or algorithms, or other algorithms 206, 214, and 220 may be referred to as “one or more AI algorithms and/or other algorithms 214”, or more simply as “intermediate AI 214”. The third of the three sets of one or more AI models and/or algorithms, or other algorithms 206, 214, and 220 may be referred to as “one or more AI algorithms 220”, or more simply as “final AI 220”.

The system 100 may provide the golf professional advice output in real time or on demand. For example, the system 100 may provide the golf professional advice output within seconds (or even milliseconds) of the system 100 receiving the user video data 204. The system 100 may be configured to require additional data to generate the golf professional advice output, such as the user swing signature data 208, the other user data 210, the user profile class data 216, the golf professional advice data 218, and/or the user feedback data 222. Alternatively, or in addition, the system 100 may generate the golf professional advice output when requested by the user device 110 and stored on the user device 110 so that it can be retrieved later (e.g., seconds later, minutes later). For example, in one scenario, the system 100 may provide the golf professional advice output to the user device 110 for immediate consumption (e.g., the golfer wants to see the advice output prior to their next swing), and in another scenario, the system 100 may provide the golf professional advice output to the user device 110 for later consumption (e.g., the golfer wants to see the advice output on the next hole).

The user video data 204 can be recorded by the user and received via the user interface 224, using a user video data source 202 comprising a mobile device (e.g., user device 110) that can capture and record images and motion, including, for example, in video format. For example, the user may record a video using a video recording app on the mobile device (e.g., user device 110) to be uploaded into the system 100 or using a video recording function that is part of the system 100. The user interface 224 may be managed by the user interface 128 of the server 120. User video data 204 is recorded and received during the system setup process, as well as at any time after the setup process if the user feels their swing has changed. The user video data 204 may be stored in a database (e.g., database 150). The user video data 204 can include any data that displays or represents the position and/or movement of the user's body, golf club, and/or golf ball during and/or as the result of the golf swing. The user video data 204 can include multiple views of the golfer's swing, including, for example, face-on and down-the-line views. The user video data 204 can include multiple golf swing and/or stroke categories, including, for example, the full swing, the pitching swing, the chipping swing, the greenside sand swing, and the putting stroke.

The system 100 executes the initial AI 206, which can receive the user video data 204 and can preprocess the user video data 204, which can include, for example, user video data 204 trimming, cropping, and standardization.

In at least one embodiment, the initial AI 206 can process the user video data 204 to identify if the user hit the golf ball with a golf club. If the user did not hit a golf ball with a golf club, the user interface 224 can generate an ‘error’ message and the user must record and submit new user video data 204. If the user did hit a golf ball with a golf club, the user interface 224 can generate an ‘accepted’ message.

The initial AI 206 can receive the user video data 204 and generate user swing signature data 208 that can be received by the intermediate AI 214. User swing signature data 208 can include, for example, one or more of: the position and/or movement of the user's body during a golf swing; the position and/or movement of the golf club relative to the user's body during a golf swing; the position of the golf ball relative to the user's body during a golf swing; and/or the golf ball direction and trajectory after the user has hit the golf ball. User swing signature data 208 can include swing signature data for multiple golf swing and/or stroke categories, including, for example, the full swing, the pitching swing, the chipping swing, the greenside sand swing, and the putting stroke.

The initial AI 206 can include any AI model and/or algorithm capable of running alone, simultaneously and/or in sequence to receive user video data 204 and generate user swing signature data 208 and can include, for example, computer vision models, computer vision algorithms, and machine learning algorithms such as unsupervised learning algorithms, supervised learning algorithms, neural network algorithms, and deep learning algorithms. Examples of computer vision models can include, for example, 2D human pose estimator models and 3D human pose estimator models (also referred to more generally as a “pose estimator”), where the models can include, for example, skeleton-based models, contour-based models and volume-based models. Examples of computer vision algorithms can include, for example, image classification algorithms, image processing algorithms, object detection algorithms, such as You Only Look Once (YOLO) and Region Based Convolutional Neural Networks (R-CNN), object tracking algorithms, motion tracking algorithms, motion estimation algorithms, semantic segmentation algorithms, and instance segmentation algorithms. Examples of unsupervised learning algorithms can include, for example, K-means, K-nearest neighbors (K-NN), Gaussian Mixture Model (GMM), hierarchical clustering, density-based clustering, and Principal Components Analysis (PCA). Examples of supervised learning algorithms can include, for example, linear regression, logistic regression, Decision Trees, Random Forests (including Bagging and Boosting, such as Ada Boost, Gradient Boosting, and XG Boost), Naïve Bayes Classifiers, Support Vector Machines (SVMs), and K-nearest neighbors. Examples of neural network algorithms can include, for example, Artificial Neural Networks (ANN), Convolutional Neural Networks (CNN), Recurrent Neural Networks (RNN), Temporal Convolutional Networks (TCN), Long Short-Term Memory (LSTM), and Autoencoders. Convolutional neural networks (CNNs) are designed to recognize images and patterns. CNNs perform convolution operations, which, for example, can be used to classify regions of an image, and see the edges of an object recognized in the image regions. Recurrent neural networks (RNNs) can be used to recognize sequences, such as text, speech, and temporal evolution, and therefore RNNs can be applied to a sequence of data to predict what will occur next. Accordingly, a CNN may be used to read what is happening on a given image at a given time, while an RNN can be used to provide an informational message. Examples of deep learning algorithms can include, for example, Deep Q-Learning, Deep Q Network (DQN), and Deep Deterministic Policy Gradient (DDPG).

In at least one embodiment, the initial AI 206 can include a supervised learning algorithm to extract key frames from the user video data 204. Key frames can include, for example, address position, golf club parallel to the ground on the backswing, lead arm parallel to the ground on the backswing, top of the backswing, lead arm parallel to the ground on the downswing, golf club parallel to the ground on the downswing, impact, golf club parallel to the ground on the follow-through, lead arm parallel to ground on the follow-through and the swing finish position. The use of key frames facilitates a more efficient and effective swing analysis by focusing on specific body and golf club positions that have the greatest influence on golf swing results and/or that contain the greatest variability among different golfers' swings. The use of key frames also facilitates the comparison of swings among different golfers, where the comparison of the different swings across the same key frames can produce a more accurate analysis.

In at least one embodiment, the initial AI 206 can include a 2D or 3D human pose estimator that can receive frames from the user video data 204 and can reduce the user video data 204 to the essential components required for analyzing the position and motion of the body during the golf swing (e.g. user swing signature data 208). As one example, the body position and motion can be represented by specifically chosen key points on, for example, the head, the shoulders, the elbows, the wrists, the hands, the spine, the hips, the knees, the ankles, and the feet. The advantages of using a human pose estimator versus a golf professional to facilitate golf swing analysis include the reduction of error and the ability to identify all positions of the body during the golf swing from different angles, within seconds. A golf professional can only process a limited amount of visual information at once and requires the viewing of repeated golf swings from the same golfer to try to identify body positions of interest, where human error can be a factor during this process. In addition, a golf professional can only process information from one angle at a time when looking at a golf swing, for example, face-on or down-the-line, which can result in additional swing analysis errors as compared to an analysis that leverages the human pose estimator's ability to process all the data from a 2-dimensional or 3-dimensional view of the body's positions during the golf swing, within seconds. Lastly, leveraging the output from a 2D or 3D human pose estimator can provide a more accurate analysis of changes in the body's position throughout the swing, as the magnitude of each change can be specifically measured. In contrast, a golf professional can visually observe general changes in the body's position, but is unable to produce exact numerical measurements for the magnitude of these changes. This can result in human error if the golf professional does not visually detect less prominent body movement changes that can be meaningful to the swing analysis.

In at least one embodiment, the initial AI 206 can include object detection algorithms that can receive frames from the user video data 204 and can identify the position of the golf club and/or the golf ball relative to the user's body. These elements contribute additional swing signature data 208 to enhance the swing analysis for each golfer and, together with the swing signature data 208 generated from the 2D or 3D human pose estimator, the same advantages apply where a golf professional does not have the ability to accurately process the totality of this visual information within seconds, and upon a single viewing.

Other user data 210 can be received via the user interface 224 during the system setup process and can include any data that can be used to help identify effective golf professional advice output suited to each golfer. Other user data 210 can include, but is not limited to, whether the user plays golf right or left-handed, the user's gender, the user's usual score during a round of golf, how many years the user has been playing golf, the user's handicap, the user's age, and the usual number of rounds the user plays in a year. Other user data 210 may be stored in a database (e.g., database 150).

User swing signature data 208 and other user data 210 can be combined to create one set of user profile data 212 for each user, and for each category of golf swing and/or stroke. User profile data 212 can be continuously updated to reflect current user swing signature data 208 that can change as a result of users submitting updated user video data 204. User profile data 212 can be received by the intermediate AI 214, to generate user profile class data 216 by clustering, grouping, and/or classifying individual user profile data 212 based on similarities and/or differences among all user profile data 212, where the clusters, groups, and/or classes can be predefined and/or not predefined. User profile class data 216 can be continuously updated to reflect new user profile data 212 from the addition of new users, as well as any changes in current user profile data 212 from changing user swing signature data 208, which allows the system 100 to continuously optimize the golf professional advice output generated for each user and their swing. User profile class data 216 can include user profile class data for multiple golf swing and/or stroke categories, including, for example, the full swing, the pitching swing, the chipping swing, the greenside sand swing, and the putting stroke.

In at least one embodiment, user swing signature data 208 is received directly by the intermediate AI 214, to generate user profile class data 216 by clustering, grouping, and/or classifying the user swing signature data 208 (e.g., for an individual user's swing) based on similarities and/or differences among all the user swing signature data 208, where the clusters, groups, and/or classes can be predefined and/or not predefined.

The intermediate AI 214 can include any AI algorithm and/or other algorithm (e.g., mathematical or statistical) capable of running alone, simultaneously and/or in sequence to cluster, group, and/or classify user swing signature data 208 or user profile data 212 and can include, for example, machine learning algorithms such as unsupervised learning algorithms, supervised learning algorithms, neural network algorithms, and deep learning algorithms, as well as other algorithms that are not related to AI. Examples of unsupervised learning algorithms can include, for example, K-means, K-nearest neighbors (K-NN), Gaussian Mixture Model (GMM), K-medoids, hierarchical clustering, density-based clustering, and Principal Components Analysis (PCA). Examples of supervised learning algorithms can include, for example, linear regression, logistic regression, Decision Trees, Random Forests (including Bagging and Boosting, such as Ada Boost, Gradient Boosting, and XG Boost), Naïve Bayes Classifiers, Support Vector Machines (SVMs), and K-nearest neighbors. Examples of neural network algorithms can include, for example, Artificial Neural Networks (ANN), Convolutional Neural Networks (CNN), Recurrent Neural Networks (RNN), Temporal Convolutional Networks (TCN), Long Short-Term Memory (LSTM), and Autoencoders. Examples of deep learning algorithms can include, for example, Deep Q-Learning, Deep Q Network (DQN), and Deep Deterministic Policy Gradient (DDPG). Examples of other mathematical or statistical algorithms can include, for example, if-else statement algorithms, tree algorithms, agglomerative clustering algorithms and Jaccard Distance algorithms.

In at least one embodiment, the intermediate AI 214 can include an unsupervised learning algorithm that receives user profile data 212 and groups or clusters this data into classes that have not been predefined, based on the similarities and/or differences among the unique user profile data 212 sets created for all users. The unsupervised learning algorithm has an advantage over a golf professional to be able to process and analyze large amounts of data at once and to identify similarities and/or differences between all the different sets of user profile data 212 that the human eye cannot see. For example, golf professionals often identify and group different golf swings into 3 classes based on the body's position at the top of the backswing, as viewed only from down-the-line. The golfer has a ‘vertical’ swing if their lead arm is above their shoulder plane, the golfer has an ‘on plane’ swing if their lead arm is in line with their shoulder plane, and the golfer has a ‘flat’ swing if their lead arm is below their shoulder plane. In another common example, golf professionals identify and group different golf swings into 3 classes based on the body's and golf club's position on the downswing, as viewed only from down-the-line. The golfer can be coming at the ball from (i) ‘the outside’, (ii) ‘the inside’, or (iii) ‘along the target line’. However, these types of classifications are solely based on one aspect of the golf swing and do not take into account the many other aspects of the golfer and/or their swing. Another advantage of the unsupervised learning algorithm over the golf professional is its ability to simultaneously process hundreds of thousands of data points to identify similarities and/or differences that exist among different golfers and their swings, resulting in a much more complex process for determining classes that reflect all the data about a user and their swing. For example, the unsupervised learning algorithm can receive all the key points generated from the 2D or 3D human pose estimator, for all the key positions in the golf swing, and for multiple views (face-on and down-the-line, for example), in addition to receiving data about the position of the golf club and the golf ball relative to the user's body for all the key positions in the golf swing, as well as receiving other user data 210 such as, for example, whether the user plays golf right or left-handed, the user's gender, the user's usual score during a round of golf, how many years the user has been playing golf, the user's handicap, the user's age, and the usual number of rounds the user plays in a year. The unsupervised learning algorithm may, for example, generate an optimal number of 7, 10, or 20 classes for the user profile class data 216, based on all the data the algorithm receives, processes, and analyzes. Identifying the optimal number of classes for the user profile class data 216 is a helpful component of the system 100, as it forms the basis for optimizing the generation of effective golf professional advice output for each golfer and their swing.

In at least one embodiment, the intermediate AI 214 can include a supervised learning algorithm that receives the user profile data 212 and classifies this data into predefined classes, in the form of user profile class data 216. User profile classes can be predefined based on, for example, one or more of: the direction of the golf ball once it is hit by the user (also referred to as ball flight); the golf club position relative to the user's body at certain points of the golf swing; the golf ball position relative to the user's body at certain points of the golf swing; the position of certain parts of the user's body at certain points of the golf swing; and other user data 210.

Golf professional advice data 218 can be received via a database (e.g., database 150) in one or more of text format, image format, audio format, and video format. The database containing golf professional advice data 218 may be populated and continuously updated with golf professional advice data 218 for a plurality of specific, predefined categories of golf situations and/or issues, provided by, for example, a particular golf professional, the collective experience of a selection of golf professionals, a plurality of golf professionals, or an AI representation of a golf professional. Golf professional advice data 218 can be received in a general format that is not pre-assigned to any cluster, group and/or class of golfer, user profile, and/or golf swing. Golf professional advice data 218 can include any data that is golf advice and/or golf-related advice provided by a golf professional that is presented in an easy-to-understand and easy-to-execute format, and can include, for example, text format, image format, audio format, and/or video format. Golf professional advice data 218 can include any data that is golf advice and/or golf-related advice that is presented in such a way that the user only needs to make minor adjustments to their current golf swing (e.g., does not require the user to make significant changes to their current golf swing). Alternatively, or in addition, the golf professional advice data 218 may include any data that is golf advice and/or golf-related advice that can be used by the user to make progressive or significant changes to their golf swing (e.g., in the form of a lesson).

In at least one embodiment, each predefined category of golf situation and/or issue stored in the database (e.g., database 150) can include a plurality of golf professional advice data 218 from a plurality of golf professionals, where the golf professional advice data 218 among the plurality of golf professionals can be different and similar, with similar items of golf professional advice data 218 being similar in content but different in the manner of presentation/communication, as a result of being provided by a different golf professional. Golf professional advice data 218 can include advice for a plurality of golf club categories and/or types, including, for example, the driver, fairway woods, hybrids, irons, wedges and the putter. Golf professional advice data 218 can include advice for a plurality of golf swing and/or stroke categories, including, for example, the full swing, the pitching swing, the chipping swing, the greenside sand swing, and the putting stroke.

In at least one embodiment, golf professional advice data 218 can include one or more of fixes, tips, and general advice. Fixes can include advice that helps users correct a specific situation or issue that the user has encountered and/or identified while playing golf and that the user wants to change. For example, a user may start to slice the ball when they do not intend to slice the ball and wants to stop slicing the ball, or the user may feel that the cause of their swing issue is that they are lifting their head during their downswing and they want to stop lifting their head. Golf professional advice data 218 that constitutes fixes for hitting a slice can include, for example, “make sure the clubface is square at address”, or “try to start your release of the clubhead earlier in the downswing”. Golf professional advice data 218 that constitutes fixes for lifting of the head during the downswing can include, for example, “feel like your head is touching the ceiling through the whole golf swing”, or “make sure your weight is on the balls of your feet”. Tips can include advice that provides users with direction in successfully dealing with a specific situation or issue that the user has encountered and/or identified while playing golf. For example, a user may want to hit a low shot under a tree, or has come upon their ball on a flat lie in a fairway bunker, and would like some advice on how to execute these specific shots. Golf professional advice data 218 that constitutes tips for hitting a low shot under a tree can include, for example, “put the ball back in your stance”, or “put more of your weight on your lead side”. Golf professional advice data 218 that constitutes tips for hitting a ball off of a flat lie in a fairway bunker can include, for example, “put your ball slightly forward in your stance”, or “shallow your swing through impact”. General advice can include golf-related advice that can help a golfer's golf game, but does not fit into the specific fixes and tips categories. Golf professional advice data 218 that constitutes general advice can include, for example, “stand behind every shot and see the target line”, or “when playing into the wind, add one extra club for each 10 mph/15 kph.”

In at least one embodiment, golf professional advice data 218 can include one or more of practice drills and lessons. Practice drills can include, for example, advice that can help a golfer improve the execution of the movements required to address a specific golf situation and/or issue that the user has encountered while playing golf. For example, a golfer may receive golf professional advice output in the form of a fix or a tip from the system 100 that is effective for them in correcting and/or dealing with a specific situation and/or issue while golfing; however, the golfer may wish to spend some additional time on improving the execution of the movement described in the fix or tip form of the golf professional advice output. Golf professional advice data 218 that constitutes practice drills can include, for example, “lay a tee down on the ground 6 inches in front of the ball, pointing to the target, and practice hitting your ball, followed by the tee”, or “place a club headcover under your right armpit and practice hitting your ball with a half swing without letting the club headcover fall to the ground”. Lessons can include advice that can help the golfer make one or more progressive or significant changes to their golf swing. Golf professional advice data 218 that constitutes lessons can include, for example, a series of practice drills that addresses a specific movement in the golf swing, for example, in the club takeaway, in the backswing, in the downswing, or in the follow-through.

User feedback data 222 can be received via the user interface 224 and can include, for example, a binary decision format, such as ‘like’/‘do not like’ or ‘useful’/‘not useful’, where a positive response can be assigned a value of 1 and a negative response can be assigned a value of 0 or negative 1, for example. User feedback data 222 can also include, for example, a scaled rating format from 1 to 5, where 5 represents strong positive feedback and 1 represents strong negative feedback.

In at least one embodiment, user profile class data 216, golf professional advice data 218, user feedback data 222, and (optionally) other user data 210, can be received by the final AI 220, which can work dynamically to continuously generate one or more effective golf professional advice outputs for each user and their swing, for each golf situation/issue category, by adapting to changing situations, using updated user profile class data 216 and updated user feedback data 222. For example, a user can take golf lessons to change their swing, which can change their user swing signature data 208, which can change their cluster, group, and/or class within the user profile class data 216. As another example, the user may find that the most effective golf professional advice output that was previously generated for them by the system 100 for a particular situation or issue may have been effective for a period of time but may no longer be as effective, due to any number of changing environmental, cognitive, or physical factors. As a result, the final AI 220 can receive this updated user feedback data 222 to make adjustments to future golf professional advice output that is generated for the user for that particular situation or issue, where the previously effective golf professional advice output is replaced by new, effective golf professional advice output.

In at least one embodiment, the user swing signature data 208, golf professional advice data 218, user feedback data 222, and (optionally) other user data 210, can be received by the final AI 220, which can work dynamically to continuously generate one or more effective golf professional advice outputs for each user and their swing, for each golf situation/issue category, by adapting to changing situations, using updated user swing signature data 208 and updated user feedback data 222.

The final AI 220 can include any artificial intelligence algorithms capable of running alone, simultaneously and/or in sequence to receive multiple inputs, which can include user feedback data 222, to create a dynamic system that continuously updates and generates one or more effective golf professional advice outputs for the user. The final AI 220 can include, for example, machine learning algorithms such as unsupervised learning algorithms, supervised learning algorithms, reinforcement learning algorithms, neural network algorithms, and deep learning algorithms. Examples of unsupervised learning algorithms can include, for example, content-based filtering, collaborative filtering, K-means, K-nearest neighbors (K-NN), Gaussian Mixture Model (GMM), K-medoids, hierarchical clustering, density-based clustering, and Principal Components Analysis (PCA). Examples of supervised learning algorithms can include, for example, linear regression, logistic regression, Decision Trees, Random Forests (including Bagging and Boosting, such as Ada Boost, Gradient Boosting, and XG Boost), Naïve Bayes Classifiers, Support Vector Machines (SVMs), and K-nearest neighbors. Examples of reinforcement learning algorithms can include, for example, Multi-Armed Bandit algorithms (such as Epsilon-Greedy algorithms, Upper Confidence Bound (UCB) algorithms, and Thompson Sampling algorithms), Q-Learning algorithms, State-Action-Reward-State-Action (SARSA) algorithms, and Temporal Difference Learning. Examples of neural network algorithms can include, for example, Artificial Neural Networks (ANN), Convolutional Neural Networks (CNN), Recurrent Neural Networks (RNN), Temporal Convolutional Networks (TCN), Long Short-Term Memory (LSTM), and Autoencoders. Examples of deep learning algorithms can include, for example, Deep Q-Learning, Deep Q Network (DQN), and Deep Deterministic Policy Gradient (DDPG).

In at least one embodiment, the final AI 220 can include one or more reinforcement learning algorithms. For example, each class in the user profile class data 216 can have its own reinforcement learning algorithm. Within each class in the user profile class data 216, there can be categories for different types of golf professional advice, such as fixes and tips, for example, and within the different categories for different types of golf professional advice there can be categories for different types of golf clubs, and within the categories for different types of golf clubs, there can be a plurality of categories for specific golf situations and/or issues. Each of these classes and subsequent categories and sub-categories can have their own reinforcement learning algorithms. The reinforcement learning algorithms can optimize the effective golf professional advice output for each user and their golf swing, within each user's class in the user profile class data 216. The reinforcement learning algorithms can receive large datasets of user feedback data 222 within each class in the user profile class data 216 and process this feedback data 222 to determine probabilities associated with each, specific golf professional advice data 218, for each golf situation and/or issue category. Subsequently, the golf professional advice output for a given golf situation and/or issue that the reinforcement learning algorithm determines has the highest probability of receiving positive user feedback can be presented to the user via the user interface 224. If the user provides negative feedback, the reinforcement learning algorithm can determine the golf professional advice output that has the next highest probability of receiving positive user feedback and can present this to the user via the user interface 224, and so on. As users use the system 100 more often, and as more users use the system 100, the reinforcement learning algorithms can continue to learn and improve the effective golf professional advice output that is generated for each user, where the effective golf professional advice output can be associated with one or more golf professionals that communicate their advice in a way that matches each golfer's learning style and ability to process information. The reinforcement learning algorithms can also provide the system 100 with the capability to continuously adapt to changing user behavior and to continuously generate updated, effective golf professional advice output, by balancing exploitation and exploration. For example, the rate of exploration can be set at a fixed rate, such as 20 percent, or it can be set at a fixed rate with a decay factor that reduces to a lesser percent value over time. Using the example of using a fixed 20 percent exploration rate, the reinforcement learning algorithm will present the golf professional advice output with the highest probabilities of receiving positive user feedback 80 percent of the time, and the reinforcement learning algorithm will present a random selection of golf professional advice output 20 percent of the time. This approach can also allow the reinforcement learning algorithm to determine if new golf professional advice data 218 that is added to the database is more or less effective than the existing golf professional advice data 218 in the database, for a particular user, for each golf situation and/or issue category.

In at least one embodiment, the final AI 220 can include a collaborative filtering algorithm (unsupervised learning) and a deep reinforcement learning algorithm that integrates Deep Q Network (DQN) implementation, in order to process more complex datasets that can be associated with a large number of users. The collaborative filtering algorithm can receive user swing signature data 208 directly, in addition to other user data 210, golf professional advice data 218, and user feedback data 222, to generate groups that have not been predefined, based on the similarities among the user swing signature data 208, user feedback data 222, and (optionally) other user data 210. The deep reinforcement learning algorithm can receive the group data generated by the collaborative filtering algorithm, in addition to the golf professional advice data 218 and user feedback data 222, and can process this data to generate one or more effective golf professional advice outputs. The deep reinforcement learning algorithm can receive large datasets of user feedback data 222 associated with each group generated by the collaborative filtering algorithm and can process this feedback data 222 to determine probabilities associated with each specific golf professional advice data 218, for each golf situation and/or issue category. Subsequently, the golf professional advice output for a given golf situation and/or issue that the deep reinforcement learning algorithm determines has the highest probability of receiving positive user feedback can be presented to the user via the user interface 224. If the user provides negative feedback, the deep reinforcement learning algorithm can determine the golf professional advice output that has the next highest probability of receiving positive user feedback and can present this to the user via the user interface 224, and so on. As users use the system 100 more often, and as more users use the system 100, the deep reinforcement learning algorithm can continue to learn and improve the effective golf professional advice output that is generated for each user, where the effective golf professional advice output can be associated with one or more golf professionals that communicate their advice in a way that matches each golfer's learning style and ability to process information. The deep reinforcement learning algorithm can also provide the system 100 with the capability to continuously adapt to changing user behavior and to continuously generate updated, effective golf professional advice output, by balancing exploitation and exploration. For example, the rate of exploration can be set at a fixed rate, such as 20 percent, or it can be set at a fixed rate with a decay factor that reduces to a lesser percent value over time. Using the example of using a fixed 20 percent exploration rate, the deep reinforcement learning algorithm presents the golf professional advice output with the highest probabilities of receiving positive user feedback 80 percent of the time, and the deep reinforcement learning algorithm presents a random selection of golf professional advice output 20 percent of the time. This approach can also allow the deep reinforcement learning algorithm to determine if new golf professional advice data 218 that is added to the database is more or less effective than the existing golf professional advice data 218 in the database, for a particular user, for each golf situation and/or issue category.

In at least one embodiment, the final AI 220 can include one or more supervised learning algorithms and one or more reinforcement learning algorithms. The supervised learning algorithms can receive one or more classes from the user profile class data 216, other user data 210, golf professional advice data 218, and user feedback data 222, and directly link these one or more classes, and (optionally) associated other user data 210, to one or more specific golf professional advice outputs. For example, if there are 5 classes of user profile class data 216, the supervised learning algorithms can receive user profile class data 216, other user data 210, golf professional advice data 218, and user feedback data 222, for 2 classes, and generate effective golf professional advice output for these 2 classes, while the reinforcement learning algorithms can receive user profile class data 216, other user data 210, golf professional advice data 218, and user feedback data 222, for the remaining 3 classes, and generate effective golf professional advice output for these other 3 classes. In the example where the supervised learning algorithms receive the user profile class data 216, other user data 210, golf professional advice data 218, and user feedback data 222, for 2 classes of user profile class data 216, the reinforcement learning algorithms can receive user feedback data 222 for these 2 classes of user profile class data 216 and implement the exploitation/exploration process to optimize the effective golf professional advice output that is presented to the user via the user interface 224.

In at least one embodiment, the final AI 220 can include one or more supervised learning algorithms that can receive user swing signature data 208 directly to generate predefined classes based on each golfer's user swing signature data 208, user feedback data 222, and (optionally) other user data 210. The one or more supervised learning algorithms can receive the user swing signature data 208, other user data 210, user feedback data 222, and golf professional advice data 218 and process this data to generate predefined classes based on similarities, and to directly link these predefined classes to one or more specific golf professional advice outputs. In addition, the one or more supervised learning algorithms can receive user feedback data 222 to update the predefined classes and/or associated golf professional advice outputs.

In at least one embodiment, one or more AI components of the system 100 (e.g., the initial AI 206, the intermediate AI 214, the final AI 220) selects a particular one of the one or more golf professional advice outputs based on rules. The one or more AI components scores at least two candidates of the one or more effective golf professional advice (e.g., a number between 0 and 1, where 0 is the lowest score and 1 is the highest score). The one or more AI components then selects one of the candidates that has the highest score. The system can then present the candidate with the highest score as the effective golf professional advice identified as being the most effective for the user. This score may be recorded for future learning of the one or more AI components of the system 100 (e.g., on its own or in conjunction with user feedback data 222).

One or more effective golf professional advice outputs for each user and their swing is received by the user via the user interface 224 (e.g., in real time or on demand) where the user interface 224 can be a graphical user interface (GUI). The user can interact with the system 100 via the user interface 224 to select the specific situation or issue that they have identified that they need help with while playing golf on any golf course, or on the driving range, and receive golf professional advice output in, for example, text format, image format, audio format, and/or video format. The user can interact with the system 100 via the user interface 224 using touch screen technology and/or voice activated technology that uses automatic speech recognition (ASR) and/or natural language processing (NLP).

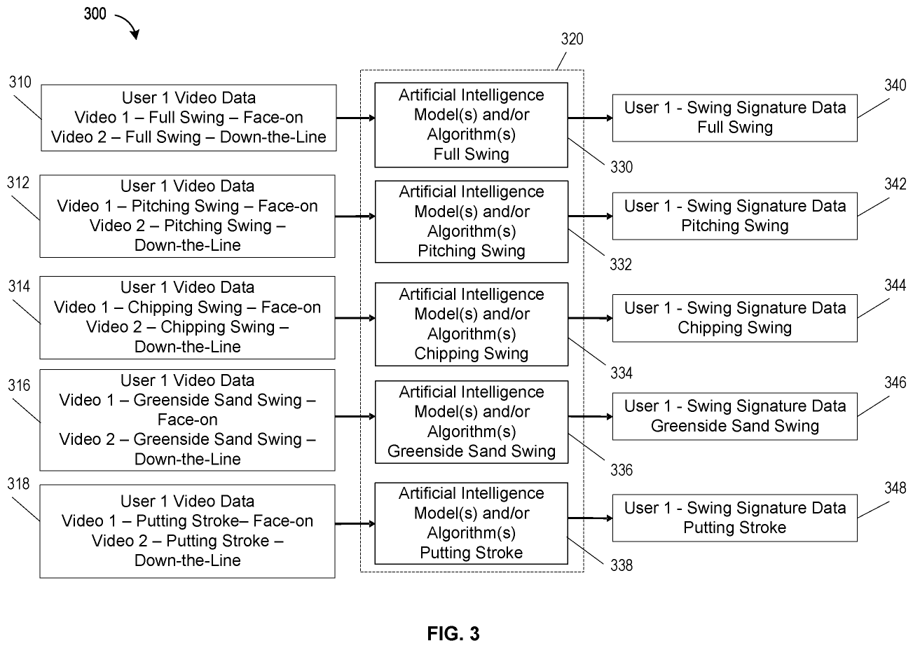

Reference is made to FIG. 3, showing a block diagram of an example embodiment of an interaction 300 between one or more of the following components of the system 100 for one user: user video data 204; initial AI 206; and user swing signature data 208.

User 1 can record and submit video data for their full swing from both face-on and down-the-line views 310, which can be received by one or more AI models and/or algorithms for the full swing 330 to generate swing signature data for User 1 for their full swing 340.

User 1 can record and submit video data for their pitching swing from both face-on and down-the-line views 312, which can be received by one or more AI models and/or algorithms for the pitching swing 332 to generate swing signature data for User 1 for their pitching swing 342.

User 1 can record and submit video data for their chipping swing from both face-on and down-the-line views 314, which can be received by one or more AI models and/or algorithms for the chipping swing 334 to generate swing signature data for User 1 for their chipping swing 344.

User 1 can record and submit video data for their greenside sand swing from both face-on and down-the-line views 316, which can be received by one or more AI models and/or algorithms for the greenside sand swing 336 to generate swing signature data for User 1 for their greenside sand swing 346.

User 1 can record and submit video data for their putting stroke from both face-on and down-the-line views 318, which can be received by one or more AI models and/or algorithms for the putting stroke 338 to generate swing signature data for User 1 for their putting stroke 348.

One or more AI models and/or algorithms 330, 332, 334, 336, and 338 can form part of a set of one or more AI models and/or algorithms 320 in the interaction 300. The one or more AI models and/or algorithms 330, 332, 334, 336, and 338 may be stored in the memory unit 138 as programs 142 and/or AI models and algorithms 146. The set of one or more AI models and/or algorithms 320 may be used as the initial AI 206.

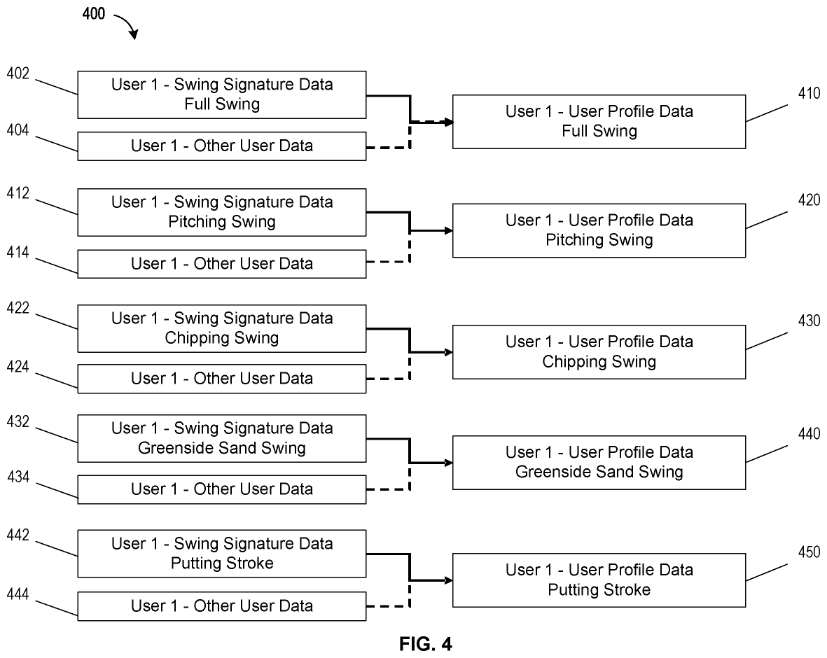

Reference is made to FIG. 4, showing a block diagram of an example embodiment of an interaction 400 between one or more of the following components of the system 100 for one user: user swing signature data 208; other user data 210; and user profile data 212.

User 1 swing signature data for their full swing 402 and other user data for User 1 404 can be combined to create one set of user profile data for User 1's full swing 410, which can be continuously updated to reflect current User 1 swing signature data for their full swing 402.

User 1 swing signature data for their pitching swing 412 and other user data for User 1 414 can be combined to create one set of user profile data for User 1's pitching swing 420, which can be continuously updated to reflect current User 1 swing signature data for their pitching swing 412.

User 1 swing signature data for their chipping swing 422 and other user data for User 1 424 can be combined to create one set of user profile data for User 1's chipping swing 430, which can be continuously updated to reflect current User 1 swing signature data for their chipping swing 422.

User 1 swing signature data for their greenside sand swing 432 and other user data for User 1 434 can be combined to create one set of user profile data for User 1's greenside sand swing 440, which can be continuously updated to reflect current User 1 swing signature data for their greenside sand swing 432.

User 1 swing signature data for their putting stroke 442 and other user data for User 1 444 can be combined to create one set of user profile data for User 1's putting stroke 450, which can be continuously updated to reflect current User 1 swing signature data for their putting stroke 442.

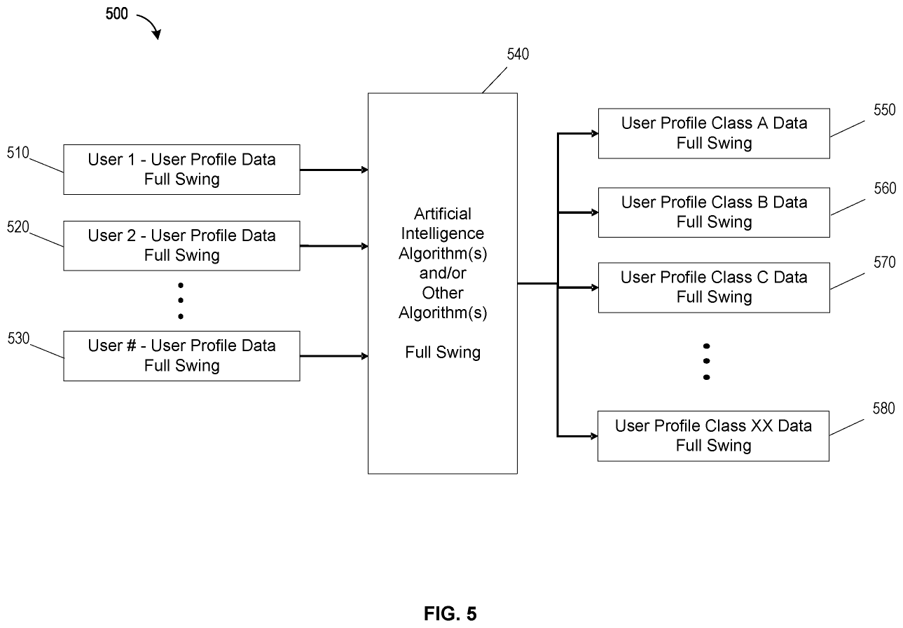

FIG. 5 shows a block diagram of an example embodiment of an interaction 500 between one or more of the following components of the system 100 for the full swing only: user profile data 212; intermediate AI 214; and user profile class data 216.

User profile data for the full swing from all users 510, 520, 530 can be received by one or more AI algorithms and/or other algorithms 540, which can cluster, group, and/or classify individual user profile data for the full swing 510, 520, 530 into multiple classes of user profile data for the full swing 550, 560, 570, 580, based on similarities and differences among all individual user profile data for the full swing 510, 520, 530. The clusters, groups, and/or classes can be predefined and/or not predefined.

User profile class data for the full swing 550, 560, 570, 580 can be continuously updated to reflect new, individual user profile data for the full swing 510, 520, 530 from the addition of new users, as well as any changes in current individual user profile data for the full swing 510, 520, 530 from changing user swing signature data for the full swing 208.

The process flow for the interaction 500 can be applied to one or more of the pitching swing, the chipping swing, the greenside sand swing, and the putting stroke, where each swing and stroke has its own set of different individual user profile data that can be received by its own set of one or more AI algorithms and/or other algorithms that can generate its own set of different, multiple user profile class data. The one or more AI algorithms and/or other algorithms 540 can form part of a set of one or more AI algorithms and/or other algorithms that may be used as the intermediate AI 214.

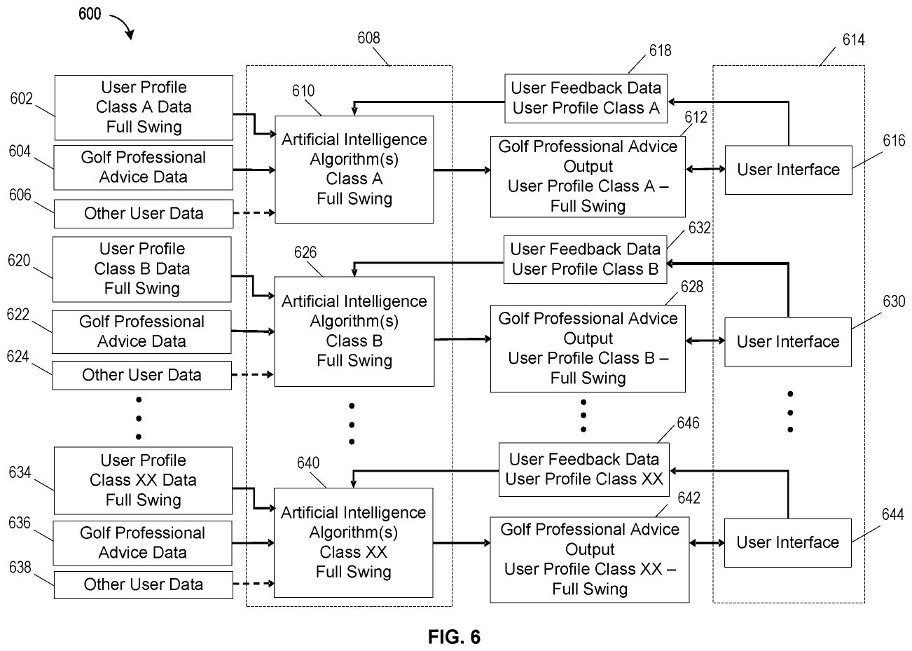

Reference is made to FIG. 6, showing a block diagram of an example embodiment of an interaction 600 between one or more of the following components of the system 100 for the full swing only: user profile class data 216; golf professional advice data 218; other user data 210; final AI 220; user feedback data 222; golf professional advice output; and user interface 224.

User profile class A data for the full swing 602, golf professional advice data 604, other user data 606, and user feedback data from user profile class A golfers 618, can be received by one or more AI algorithms for the full swing for user profile class A 610 to generate one or more effective golf professional advice outputs for the full swing for each user within user profile class A 612. The one or more effective golf professional advice outputs can be received by a user profile class A golfer via the user interface 616 (which may be managed by the user interface 128 of the server 120).

User profile class B data for the full swing 620, golf professional advice data 622, other user data 624, and user feedback data from user profile class B golfers 632, can be received by one or more AI algorithms for the full swing for user profile class B 626 to generate one or more effective golf professional advice outputs for the full swing for each user within user profile class B 628. The one or more effective golf professional advice outputs can be received by a user profile class B golfer via the user interface 630 (which may be managed by the user interface 128 of the server 120).

User profile class XX data for the full swing 634, golf professional advice data 636, other user data 638, and user feedback data from user profile class XX golfers 646, can be received by one or more AI algorithms for the full swing for user profile class XX 640 to generate one or more effective golf professional advice outputs for the full swing for each user within user profile class XX 642, which can be received by a user profile class XX golfer via the user interface 644 (which may be managed by the user interface 128 of the server 120). Class XX represents any number, where the number of classes, groups, and/or clusters for user profile class data 216 is dynamic and can change as a result of changing and/or new user profile data 212 from the addition of new users, as well as any changes in current user profile data 212 from changing user swing signature data 208.

One or more AI algorithms 610, 626, and 640 form part of a set of one or more AI algorithms 608 in the interaction 600. User interface 616, 630, and 644 can be the same user interface for all users 614. The set of one or more AI algorithms 608 can form part of a set of one or more AI algorithms that may be used as the final AI 220.

The process flow diagram 600 can be applied to one or more of the pitching swing, the chipping swing, the greenside sand swing, and the putting stroke, where each swing and stroke has its own set of different user profile class data, its own set of different golf professional advice data, its own set of the same and/or different other user data, and its own set of different user feedback data for users in each user profile class, that can be received by its own set of one or more AI algorithms that can generate its own set of one or more effective golf professional advice outputs for each user within each user profile class.

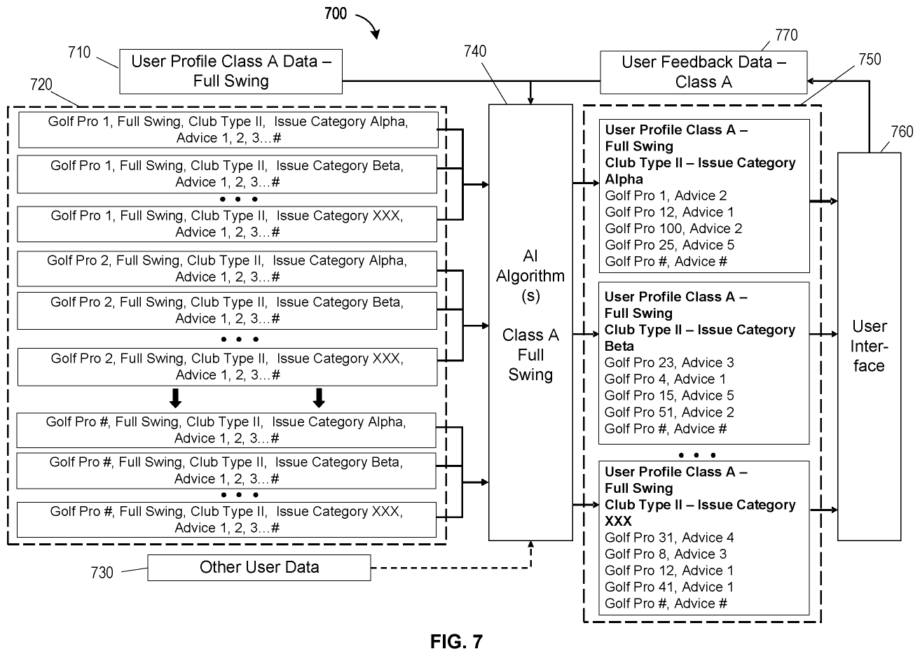

FIG. 7 shows a block diagram of an example embodiment illustrating data flow 700 for how golf professional advice data 218 can be received by the system 100 and one example of how golf professional advice output can be generated for the full swing for users in user profile class A only, for one point in time. The following components of the system 100 are referenced: user profile class data 216; golf professional advice data 218; other user data 210; final AI 220; user feedback data 222; and user interface 224.

User profile class A data for a full swing 710, golf professional advice data for the full swing 720 (for club type II), other user data 730, and user feedback data from user profile class A golfers 770 can be received by one or more AI algorithms for the full swing for user profile class A 740 to generate one or more effective golf professional advice outputs for the full swing, for club type II, for each situation and/or issue category, for each user within user profile class A 750, which can be received by a user profile class A golfer via the user interface 760 (which may be managed by the user interface 128 of the server 120). Issue category XXX (for the golf professional advice data for the full swing 720 and the golf professional advice outputs for the full swing, for club type II, for each user within user profile class A 750) represents any number, as there is a plurality of situation and issue categories, where the number of situation and issue categories can change. The one or more AI algorithms for the full swing for user profile class A 740 can form part of a set of one or more AI algorithms that may be used as the final AI 220.

Golf professional advice data for the full swing 720 can be received via a database (e.g., database 150) in one or more of text format, image format, audio format, and/or video format. The database containing golf professional advice data for the full swing 720 may be populated and continuously updated with golf professional advice data for the full swing 720 for a plurality of specific, predefined categories of golf situations and/or issues, provided by, for example, a particular golf professional, the collective experience of a selection of golf professionals, a plurality of golf professionals, or an AI representation of a golf professional.

Golf professional advice data for the full swing 720 can be received in a general format that is not pre-assigned to any cluster, group, and/or class of golfer, user profile, and/or golf swing. Golf professional advice data for the full swing 720 can include any data that is golf advice and/or golf-related advice provided by a golf professional that is presented in an easy-to-understand and easy-to-execute format, and can include, for example, text format, image format, audio format, and/or video format. Golf professional advice data for the full swing 720 can include any data that is golf advice and/or golf-related advice that is presented in such a way that the user only needs to make minor adjustments to their current golf swing (e.g., does not require the user to make significant changes to their current golf swing). Alternatively, or in addition, the golf professional advice data for the full swing 720 may include any data that is golf advice and/or golf-related advice that can be used by the user to make progressive or significant changes to their golf swing (e.g., in the form of a lesson).

In at least one embodiment, each predefined category of golf situation and/or issue can include a plurality of golf professional advice data for the full swing 720 from a plurality of golf professionals, where the golf professional advice data for the full swing 720 among the plurality of golf professionals can be both different and similar, with similar items of golf professional advice data for the full swing 720 being similar in content but different in the manner of presentation/communication, as a result of being provided by a different golf professional. Golf professional advice data for the full swing 720 can include advice for a plurality of golf club categories and/or types, including, for example, the driver, fairway woods, hybrids, and irons, as illustrated by the use of the term “club type II” in data flow 700.

One or more effective golf professional advice outputs for the full swing, for club type II, for each situation or issue category, for each user within user profile class A 750 is an example of the output that can be generated by one or more AI algorithms 740 for the full swing for user profile class A, for one point in time. The system 100 can be dynamic and constantly updating to generate one or more effective golf professional advice outputs from the same and/or different golf professionals, for each golf club category and/or type, for each predefined category of golf situation and/or issue, and for each user within each user profile class.

The data flow 700 can be applied to a plurality of user profile classes for the full swing, where each class has its own different user profile class data, the same golf professional advice data for the full swing, and the same and/or different other user data, that can be received by its own set of one or more AI algorithms that can generate its own set of one or more effective golf professional advice outputs for each user within each user profile class.

The data flow 700 can also be applied to one or more of the pitching swing, the chipping swing, the greenside sand swing, and the putting stroke, where each swing and stroke has its own set of different, multiple user profile classes and their corresponding data, its own set of different golf professional advice data, its own set of the same and/or different other user data, and its own set of different user feedback data for users in each user profile class, that can be received by its own set of one or more AI algorithms that can generate its own set of one or more effective golf professional advice outputs for each user within each user profile class.

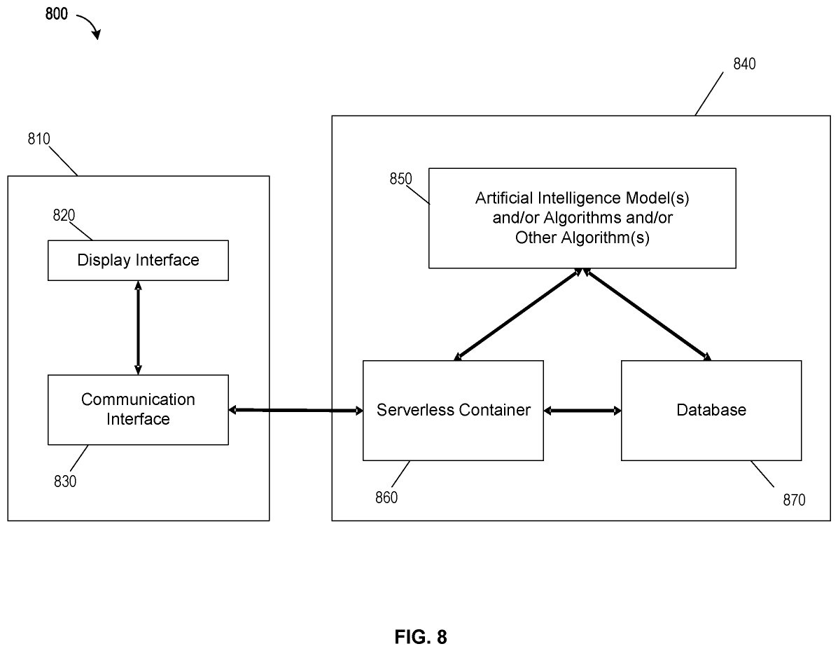

Reference is made to FIG. 8, showing a block diagram of an example embodiment of an overall infrastructure 800 of the system 100, which can include a mobile device 810 (which may be user device 110) that can capture and record images and motion, including, for example, in video format, and an internet-based infrastructure 840, including, for example, the cloud.

The mobile device 810 can include a display interface 820 that the user can use to communicate with the system 100, and a communication interface 830 that the system 100 can use to communicate between the display interface 820 and the serverless container 860 in the internet-based infrastructure 840.

The internet-based infrastructure 840 can include the AI models and/or algorithms and/or other algorithms 850, a serverless container 860, and a database 870 (which may be stored as database 150), which can all communicate with each other. The serverless container 860 can dynamically allocate the computing resources needed to support the system 100 and can contain infrastructure components, including a virtual private cloud (VPC) and a subnet, which can communicate with the public internet, as well as other infrastructure components, including an operating system (OS), random access memory (RAM), hard drive memory, a port, and a Docker image, which can be used to execute code. The database 870 can store the data for the system 100 and can contain infrastructure components, including a VPC, a subnet, an OS, RAM and hard drive memory.

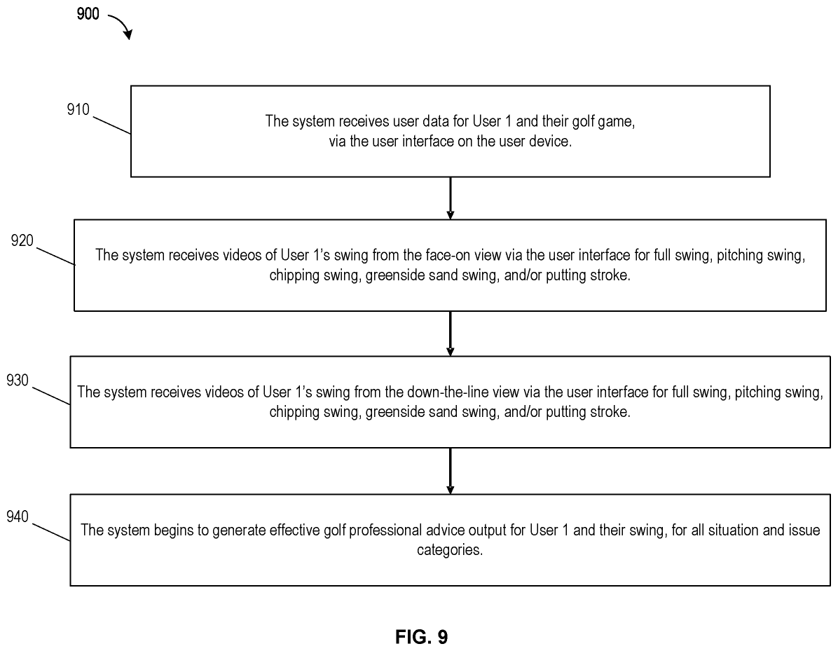

FIG. 9, shows a flowchart of an example embodiment illustrating a setup process 900 for a new user, User 1, when using the system 100 for the first time. In process 900, User 1 may access the system 100 on user device 110 (e.g., a mobile device) through a user interface (which may be managed by the user interface 128 of the server 120).

At 910, the system 100 receives a first set of data from User 1 via the user interface on user device 110 about User 1 and their golf game (e.g., other user data 210), which can include, but is not limited to, if the user plays golf right or left-handed, the user's gender, the user's usual score during a round of golf, how many years the user has been playing golf, the user's handicap, the user's age, and the usual number of rounds the user plays in a year.

At 920 and 930, the system 100 receives video data via the user interface of user device 110. In particular, User 1 may use the user interface of the system 100 on user device 110 to record and submit a video of them hitting a golf ball from both face-on and down-the-line views for one or more of the full swing, the pitching swing, the chipping swing, the greenside sand swing, and the putting stroke. Alternatively, User 1 may record a video using a video recording app on user device 110 to be uploaded into the system 100. Upon completion of 920 and 930, the system 100 has completed the setup process for User 1.

At 940, the system 100 begins to generate one or more effective golf professional advice outputs for User 1 and their swing, for all situation and issue categories.

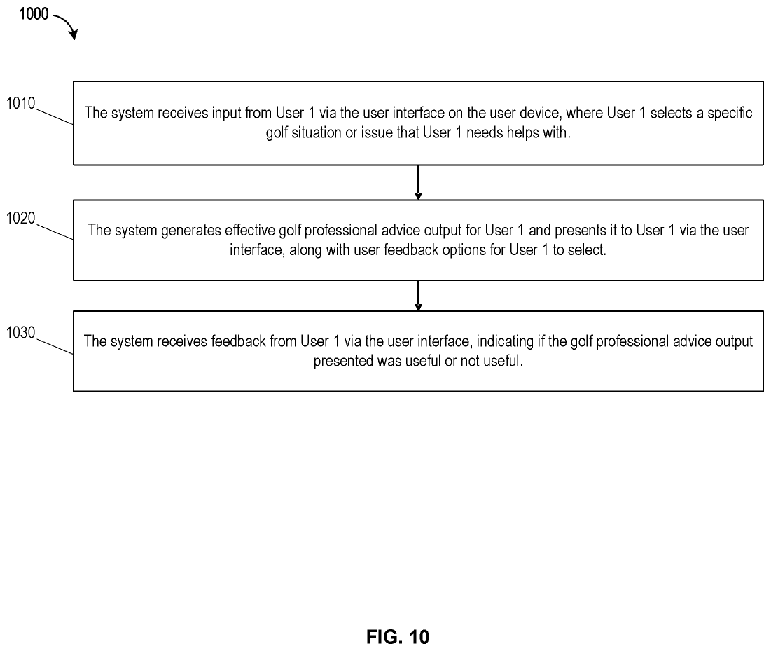

Reference is made to FIG. 10, showing a flowchart of an example embodiment of an interaction 1000 of a user, User 1, with the system 100. In process 1000, User 1 may access the system 100 on user device 110 (e.g., a mobile device) through a user interface (which may be managed by the user interface 128 of the server 120).

At 1010, the system 100 receives input from User 1 via the user interface on user device 110 (e.g., a mobile device), where User 1 uses touch screen technology and/or voice activated technology to select a specific golf situation or issue that User 1 needs help with, while playing golf. For example, User 1 may be slicing the ball or lifting their head and wants help correcting these issues, or User 1 may want to hit a low shot under a tree or hit their ball out of a fairway bunker and wants help with how to execute these golf shots.

At 1020, the system 100 generates one or more effective golf professional advice outputs for User 1 (e.g., in real time or on demand) and presents the golf professional advice output to User 1 via the user interface on user device 110, along with user feedback options for User 1 to select.

At 1030, the system 100 receives feedback from User 1 via the user interface on user device 110, indicating if the golf professional advice output presented was useful or not useful.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. An automated system for analyzing a golf swing video and generating golf professional advice using artificial intelligence (AI) comprising:
at least one processor;
a non-transitory computer-readable medium having stored thereon instructions that, when executed by the at least one processor, cause the at least one processor to carry out the steps of:
receiving user video data from a user device;
generating user swing signature data from the user video data using an initial AI that takes as input the user video data;
generating one or more golf professional advice outputs from the user swing signature data using a final AI; and
sending the one or more golf professional advice outputs to the user device for use to cause to be output on the user device.

2. The automated system of claim 1, wherein the final AI takes as input the user swing signature data and golf professional advice data.

3. The automated system of claim 2, wherein the final AI further takes as input other user data.

4. The automated system of claim 1, wherein the instructions further cause the at least one processor to carry out the step of:
generating user profile class data based at least in part on the user swing signature data and an intermediate AI;
and wherein the final AI takes as input the user profile class data and golf professional advice data.

5. The automated system of claim 1, wherein the instructions further cause the at least one processor to carry out the steps of:
generating user profile data based at least in part on the user swing signature data and other user data; and
generating user profile class data based at least in part on the user profile data and an intermediate AI;
and wherein the final AI takes as input the user profile class data and golf professional advice data.

6. The automated system of claim 1, wherein the user video data received from the user device is recorded video that captured a golf swing or stroke.

7. The automated system of claim 1, wherein the generating the one or more golf professional advice outputs is done at least in part by the final AI scoring at least two candidates for advice and selecting the one of the at least two candidates with a higher score.

8. The automated system of claim 7, wherein the scoring of the at least two candidates is based at least in part on user feedback data.

9. The automated system of claim 1, wherein the initial AI is a pose estimator.

10. The automated system of claim 1, wherein the final AI further takes as input user feedback data.

11. An automated method for analyzing a golf swing video and generating golf professional advice using artificial intelligence (AI) comprising:
receiving user video data from a user device;
generating user swing signature data from the user video data using an initial AI that takes as input the user video data;
generating one or more golf professional advice outputs from the user swing signature data using a final AI; and
sending the one or more golf professional advice outputs to the user device for use to cause to be output on the user device.

12. The automated method of claim 11, wherein the final AI takes as input the user swing signature data and golf professional advice data.

13. The automated method of claim 12, wherein the final AI further takes as input other user data.

14. The automated method of claim 11, further comprising:
generating user profile class data based at least in part on the user swing signature data and an intermediate AI;
and wherein the final AI takes as input the user profile class data and golf professional advice data.

15. The automated method of claim 11, further comprising:
generating user profile data based at least in part on the user swing signature data and other user data; and
generating user profile class data based at least in part on the user profile data and an intermediate AI;
and wherein the final AI takes as input the user profile class data and golf professional advice data.

16. The automated method of claim 11, wherein the user video data received from the user device is recorded video that captured a golf swing or stroke.

17. The automated method of claim 11, wherein the generating the one or more golf professional advice outputs is done at least in part by the final AI scoring at least two candidates for advice and selecting the one of the at least two candidates with a higher score.

18. The automated method of claim 17, wherein the scoring of the at least two candidates is based at least in part on user feedback data.

19. The automated method of claim 11, wherein the initial AI is a pose estimator.

20. The automated method of claim 11, wherein the final AI further takes as input user feedback data.
